(19) United States
(12) Patent Application Publication
(10) Pub. No.: US 2016/0020459 A1
(43) Pub. Date: Jan. 21, 2016

(54) NONAQUEOUS ELECTROLYTE SECONDARY BATTERY

(71) Applicant: SANYO ELECTRIC CO., LTD., Daito-shi, Osaka (JP)

(72) Inventors: Daisuke Nishide, Hyogo (JP); Atsushi Mizawa, Osaka (JP); Fumiharu Niina, Hyogo (JP); Hiroyuki Fujimoto, Osaka (JP); Takeshi Ogasawara, Hyogo (JP)

(73) Assignee: SANYO Electric Co., Ltd., Daito-shi, Osaka (JP)

(21) Appl. No.: 14/773,448

(22) PCT Filed: Mar. 13, 2014
(86) PCT No.: PCT/JP2014/001440

§ 371 Date: Sep. 8, 2015

(30) Foreign Application Priority Data
Mar. 27, 2013 (JP) 2013-066232

(51) Int. Cl. H01M 4/36; H01M 10/052; H01M 4/505; H01M 4/525; H01M 10/0568; H01M 4/485

(52) U.S. Cl. CPC H01M 4/366; H01M 10/0568; H01M 4/485; H01M 4/505; H01M 4/525; H01M 10/052; H01M 2004/028

(57) ABSTRACT

The present invention has a main object to improve the thermal stability of a nonaqueous electrolyte secondary battery. A nonaqueous electrolyte secondary battery according to an aspect of the present invention includes a positive electrode, a negative electrode, and a nonaqueous electrolyte. The positive electrode contains a positive electrode active material and a metal fluoride. The positive electrode active material contains particles of a lithium transition metal oxide. At least one portion of the surface of each of the lithium transition metal oxide particles has a rare-earth compound attached thereto. The nonaqueous electrolyte contains a fluorine-containing lithium salt. The rare-earth compound is preferably a hydroxide, an oxyhydroxide, or an oxide.

### TECHNICAL FIELD

The present invention relates to a nonaqueous electrolyte secondary battery.

### BACKGROUND ART

In the field of nonaqueous electrolyte secondary batteries, various properties such as high capacity, long life, and high safety are required to be further improved. Patent Literature 1 proposes that lithium transition metal oxide particles are surface-coated with a lithium compound, whereby the dissociation of primary particles is prevented and the increase in internal resistance and the reduction in capacity of batteries are suppressed.

### CITATION LIST

### Patent Literature

PTL 1: Japanese Published Unexamined Patent Application No. 2006-318815

### SUMMARY OF INVENTION

### Technical Problem

However, in the above proposal, improvements in terms of the thermal stability of batteries are insufficient. When the thermal stability of a battery is insufficient, the battery needs to be provided with many safety mechanisms in preparation for the increase in temperature of the battery. This causes increases in costs of the battery and a device using the battery.

The present invention has a main object to improve the thermal stability of a nonaqueous electrolyte secondary battery.

### Solution to Problem

A nonaqueous electrolyte secondary battery according to an aspect of the present invention includes a positive electrode, a negative electrode, and a nonaqueous electrolyte. The positive electrode contains a positive electrode active material and a metal fluoride. The positive electrode active material contains particles of a lithium transition metal oxide. At least one portion of the surface of each of the lithium transition metal oxide particles has a rare-earth compound attached thereto. The nonaqueous electrolyte contains a fluorine-containing lithium salt.

### Advantageous Effect of Invention

In accordance with a nonaqueous electrolyte secondary battery according to an aspect of the present invention, the thermal stability of a battery can be enhanced.

### DESCRIPTION OF EMBODIMENTS

An example of a metal fluoride is a fluoride of lithium (Li), sodium (Na), magnesium (Mg), calcium (Ca), aluminium (Al), titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), tantalum (Ta), tin (Sn), tungsten (W), potassium (K), barium (Ba), or strontium (Sr). In particular, a fluoride of lithium (Li), sodium (Na), magnesium (Mg), calcium (Ca), or zirconium (Zr) is preferred and LiF, NaF, MgF₂, CaF₂, or ZrF₄ is preferred.

The ratio of the metal fluoride to the total mass of a lithium transition metal oxide is preferably 0.1 mass percent to 5.0 mass percent, more preferably 0.5 mass percent to 4.0 mass percent, and further more preferably 1.1 mass percent to 3.4 mass percent. When the above ratio is less than 0.1 mass percent, the effect of enhancing thermal stability may possibly be small. When the above ratio exceeds 5.0 mass percent, the amount of a positive electrode active material is proportionally reduced and therefore the capacity of a positive electrode is reduced.

A rare-earth compound is preferably a rare-earth hydroxide, oxyhydroxide, or oxide. In particular, the rare-earth compound is preferably the rare-earth hydroxide or oxyhydroxide. This is because the use of the rare-earth hydroxide or oxyhydroxide allows the effect of enhancing thermal stability to be further exhibited. The rare-earth compound may partly contain a rare-earth carbonate or phosphate.

Examples of a rare-earth element contained in the rare-earth compound include scandium, yttrium, lanthanum, cerium, praseodymium, neodymium, samarium, europium, gadolinium, terbium, dysprosium, holmium, erbium, thulium, ytterbium, and lutetium. In particular, neodymium, samarium, and erbium are preferred. This is because a compound of neodymium, samarium, or erbium has a smaller average particle size as compared to other rare-earth compounds and is likely to be uniformly deposited on the surfaces of particles of the lithium transition metal oxide.

Examples of the rare-earth compound include neodymium hydroxide, neodymium oxyhydroxide, samarium hydroxide, samarium oxyhydroxide, erbium hydroxide, and erbium oxyhydroxide. When the rare-earth compound used is lanthanum hydroxide or lanthanum oxyhydroxide, manufacturing costs of the positive electrode can be reduced because lanthanum is inexpensive.

The rare-earth compound preferably has an average particle size of 1 nm to 100 nm and more preferably 10 nm to 50 nm. When the average particle size of the rare-earth compound is more than 100 nm, the size of particles of the rare-earth compound is large and the number of the rare-earth compound particles is small. Therefore, the effect of enhancing thermal stability may possibly be small. However, when the average particle size of the rare-earth compound is less than 1 nm, the surfaces of the lithium transition metal oxide particles are densely covered by the rare-earth compound. This may possibly reduce the storage or release performance of lithium ions on the surfaces of the lithium transition metal oxide particles, leading to reductions in charge/discharge characteristics.

The following method is used to attach the rare-earth compound to the surfaces of the lithium transition metal oxide particles: a method in which an aqueous solution containing a salt of the rare-earth element is mixed with a solution containing the lithium transition metal oxide particles dispersed therein and the rare-earth element salt is deposited on the surfaces of the lithium transition metal oxide particles, followed by heat treatment. In this method, the rare-earth compound can be uniformly dispersed and attached to the surfaces of the lithium transition metal oxide particles. The pH of the solution containing the lithium transition metal oxide particles is preferably maintained constant. In particular, in order to uniformly disperse and attach fine particles of 1 nm to 100 nm to the surfaces of the lithium transition metal oxide particles, the pH thereof is preferably limited to 6 to 10. When the pH thereof is less than 6, a transition metal in the lithium transition metal oxide may possibly be dissolved out. However, when the pH thereof is more than 10, the rare-earth element may possibly be segregated. The temperature of heat treatment depends on the type of the rare-earth element and is preferably 120° C. to 700° C. and more preferably 250° C. to 500° C. when the rare-earth element is, for example, erbium. When the heat treatment temperature is lower than 120° C., moisture adsorbed on an active material is not sufficiently removed and therefore may possibly enter batteries. However, when the heat treatment temperature is higher than 700° C., a portion of the rare-earth compound attached to the surfaces diffuses into inner portions and therefore the effect of enhancing thermal stability may possibly be reduced.

There is another method in which an aqueous solution containing a salt of the rare-earth element is sprayed while being mixed with the lithium transition metal oxide, followed by drying. Furthermore, there is another method in which the lithium transition metal oxide and the rare-earth compound are mixed together using a mixer such that the rare-earth compound is mechanically attached to the surface of the lithium transition metal oxide. In the other methods, heat treatment may be further performed. The temperature of heat treatment in this case is the same as the heat treatment temperature in the case of mixing the above aqueous solution.

The abundance ratio of the rare-earth element to the total molar amount of the transition metal in the lithium transition metal oxide is preferably 0.003 mole percent to 0.25 mole percent, more preferably 0.01 mole percent to 0.20 mole percent, and further more preferably 0.05 mole percent to 0.15 mole percent. When the above ratio is less than 0.003 mole percent, the effect of enhancing thermal stability may possibly be small. However, when the above ratio is more than 0.25 mole percent, the surface reactivity of the lithium transition metal oxide particles is low and therefore cycle characteristics for large-current discharge may possibly be reduced.

The transition metal element in the lithium transition metal oxide preferably contains nickel and manganese. When the lithium transition metal oxide contains nickel and manganese, the lithium transition metal oxide has higher thermal stability as compared to LiNiO₂. Therefore, the influence of the oxidation of a nonaqueous electrolyte by the catalysis of the transition metal in the lithium transition metal oxide is greater than the influence of the oxidation of the nonaqueous electrolyte by oxygen eliminated from the lithium transition metal oxide at high temperature. The present invention is suitable for suppressing the oxidation of the nonaqueous electrolyte by the catalysis of the transition metal. When the lithium transition metal oxide contains nickel and manganese, effects of the present invention are achieved.

When the lithium transition metal oxide contains nickel and manganese, the oxidation of the nonaqueous electrolyte by the catalysis of the transition metal is great as compared to LiCoO₂. Thus, when the lithium transition metal oxide contains nickel and manganese, effects of the present invention are achieved.

The lithium transition metal oxide is preferably represented by the formula Li₁₊ₓNiₐMn_{b}Co_{c}O_{2+d} (where x, a, b, and c satisfy x+a+b+c=1.0, 0≦x≦0.3, 0<a, 0<b, c, and −0.1≦d≦0.1) and is preferably represented by the formula Li₁₊ₓNiₐMn_{b}Co_{c}O_{2+d} (where x, a, b, c, and d satisfy x+a+b+c=1.0, 0≦x≦0.3, 0≦c/(a+b)<0.85, 0.7≦a/b≦4.0, and −0.1≦d≦0.1).

Since material costs are reduced, the condition 0≦c/(a+b)<0.85 is preferably satisfied and the condition 0≦c/(a+b)<0.65 is more preferably satisfied. Since the thermal stability of the lithium transition metal oxide is increased, the condition 0.7≦a/b≦4.0 is preferably satisfied and the condition 0.7≦a/b≦3.0 is more preferably satisfied. The lithium transition metal oxide preferably has a layered structure.

The lithium transition metal oxide may contain an additive element to such an extent that the effect of enhancing thermal stability is impaired. Examples of the additive element include boron (B), magnesium (Mg), aluminium (Al), titanium (Ti), chromium (Cr), vanadium (V), iron (Fe), copper (Cu), zinc (Zn), niobium (Nb), molybdenum (Mo), tantalum (Ta), zirconium (Zr), tin (Sn), tungsten (W), sodium (Na), potassium (K), barium (Ba), strontium (Sr), and calcium (Ca).

In the present invention, a negative electrode active material used in a negative electrode is not particularly limited and may be one capable of reversibly storing and releasing lithium. The negative electrode active material may be, for example, a carbon material, a metal or alloying material alloying with lithium, a metal oxide, or the like.

The nonaqueous electrolyte is used in a nonaqueous electrolyte secondary battery according to the present invention and may be a conventional cyclic carbonate such as ethylene carbonate, propylene carbonate, butylene carbonate, or vinylene carbonate or a conventional linear carbonate such as dimethyl carbonate, methyl ethyl carbonate, or diethyl carbonate. In particular, a solvent mixture of a cyclic carbonate and a linear carbonate is a nonaqueous solvent having low viscosity, a low melting point, and high lithium ion conductivity and is preferably used. The volume ratio of the cyclic carbonate to the linear carbonate preferably ranges from 2:8 to 5:5.

A lithium salt used in the nonaqueous electrolyte secondary battery according to the present invention may be, for example, a conventional fluorine-containing lithium salt, such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, or LiAsF₆. Furthermore, one obtained by adding a lithium salt (a lithium salt (for example, LiClO₄ or the like) containing one or more of P, B, O, S, N, and Cl) other than the fluorine-containing lithium salt to the fluorine-containing lithium salt may be used. In particular, the fluorine-containing lithium salt and a lithium salt containing an oxalato complex in the form of an anion are preferably contained from the viewpoint of forming a stable coating on a surface of the negative electrode even in a high-temperature environment.

Examples of the lithium salt containing the oxalato complex in the form of an anion include LiBOB (lithium bis(oxalato)borate), Li[B(C₂O₄)F₂], Li[P(C₂O₄) F₄], and Li[P(C₂O₄)₂F₂]. In particular, LiBOB is preferably used because a stable coating is formed.

A separator used in the nonaqueous electrolyte secondary battery according to the present invention may be a conventional separator made of polypropylene or polyethylene, a polypropylene-polyethylene multilayer separator, or the like.

### EXPERIMENT EXAMPLES

The present invention is further described below in detail with reference to experiment examples. The present invention is not limited to the experiment examples. Modifications can be made without departing from the scope of the present invention.

### Experiment Example 1

### Preparation of Positive Electrode Active Material

After [Ni_{0.35}Mn_{0.30}0CO_{0.35}](OH)₂ prepared by a coprecipitation method and Li₂CO₃ were mixed together, the mixture was fired at 900° C. for 10 hours in air, whereby a lithium transition metal oxide represented by the formula Li_{1.06}[Ni_{0.33}Mn_{0.28}0CO_{0.33}]O₂ was prepared as a positive electrode active material. The lithium transition metal oxide had an average particle size of about 12 μm.

Into pure water, 1,000 g of particles of the lithium transition metal oxide prepared by the above method were put, followed by stirring and then adding a solution containing 4.58 g of erbium nitrate tetrahydrate thereto. In this operation, a 10 mass percent aqueous solution of sodium hydroxide was appropriately added, whereby the pH of a solution containing the lithium transition metal oxide was adjusted to 9. Next, after suction filtration and water washing were performed, powder obtained by firing at 400° C. was dried, whereby a positive electrode active material containing the lithium transition metal oxide and erbium oxyhydroxide uniformly attached to the surface of the lithium transition metal oxide was obtained. Incidentally, the amount of the attached erbium oxyhydroxide was 0.1 mole percent of the total molar amount of a transition metal in the lithium transition metal oxide and the erbium oxyhydroxide in terms of erbium.

[Preparation of Positive Electrode]

The positive electrode active material, lithium fluoride, a conductive agent, and an N-methyl-2-pyrrolidone solution containing a binder were weighed such that the mass ratio of the positive electrode active material to lithium fluoride to the conductive agent to the binder was 91:1:5:3. The conductive agent was carbon black. The binder was polyvinylidene fluoride. These components were kneaded, whereby positive electrode mix slurry was prepared. The ratio of lithium fluoride to the positive electrode active material was 1.1 mass percent. Next, the positive electrode mix slurry was applied to both surfaces of a positive electrode current collector made from aluminium foil. The positive electrode current collector was dried and was then rolled with a rolling roller. A current-collecting tab made of aluminium was attached to the positive electrode current collector, whereby a positive electrode was prepared.

A three-electrode test cell was prepared using the positive electrode as a working electrode, a metallic lithium electrode as a counter electrode, and a metallic lithium electrode as a reference electrode. A nonaqueous electrolyte used was a nonaqueous electrolytic solution which was prepared in such a manner that LiPF6, LiBOB, and 1 mass percent of vinylene carbonate were dissolved in a solvent mixture obtained by mixing ethylene carbonate, methyl ethyl carbonate, and dimethyl carbonate at a volume ratio of 3:3:4 such that the concentration of LiPF6 was 1 mol/L and the concentration of LiBOB was 0.1 mol/L. The three-electrode test cell prepared as described above is hereinafter referred to as Battery A1.

### Experiment Example 2

A three-electrode test cell was prepared in substantially the same manner as that described in Experiment Example 1 except that positive electrode mix slurry used to prepare a positive electrode was prepared in such a manner that the positive electrode active material, lithium fluoride, the conductive agent, and the binder were weighed such that the mass ratio of the positive electrode active material to lithium fluoride to the conductive agent to the binder was 89:3:5:3, followed by kneading these components. In the positive electrode mix slurry, the ratio of lithium fluoride to the positive electrode active material was 3.4 mass percent. The three-electrode test cell prepared as described above is hereinafter referred to as Battery A2.

### Experiment Example 3

A three-electrode test cell was prepared in substantially the same manner as that described in Experiment Example 1 except that no erbium oxyhydroxide was attached to the surfaces when a positive electrode active material was prepared or no lithium fluoride was added when a positive electrode was prepared. The three-electrode test cell prepared as described above is hereinafter referred to as Battery Z1.

### Experiment Example 4

A three-electrode test cell was prepared in substantially the same manner as that described in Experiment Example 1 except that no erbium oxyhydroxide was attached to the surfaces when a positive electrode active material was prepared. The three-electrode test cell prepared as described above is hereinafter referred to as Battery Z2.

### Experiment Example 5

A three-electrode test cell was prepared in substantially the same manner as that described in Experiment Example 1 except that no lithium fluoride was added when a positive electrode was prepared. The three-electrode test cell prepared as described above is hereinafter referred to as Battery Z3.

### (Thermal Stability Test)

After Batteries A1, A2, and Z1 to Z3 were charged under conditions below, each battery was disassembled and the positive electrode was taken out of the battery. The positive electrode was put in a cell made of SUS together with a nonaqueous electrolytic solution. The cell was sealed and was then heated to 350° C. at a rate of 5° C. per minute. The heating value was measured at 160° C. to 240° C. using a differential scanning calorimeter (DSC). The results are shown in Table 1. The heating value of each battery is expressed as an index, where the heating value of Battery Z1 is 100.

•Charge Conditions

Under 25° C. temperature conditions, constant-current charge was performed at a current density of 0.2 mA/cm² until 4.3 V (vs. Li/Li⁺) and constant-voltage charge was performed at a constant voltage 4.3 V (vs. Li/Li⁺) until the current density reached 0.04 mA/cm².

TABLE 1

| | Attachment of erbium | Addition of lithium | |
|---|---|---|---|
| | oxyhydroxide | fluoride | Heating |
| Battery | (amount) | (amount) | value |
| A1 | Attached | Added | 69 |
| | (0.1 mole percent) | (1.1 mass percent) | |
| A2 | Attached | Added | 68 |
| | (0.1 mole percent) | (3.4 mass percent) | |
| Z1 | Not attached | Not added | 100 |
| Z2 | Not attached | Added | 91 |
| | | (1.1 mass percent) | |
| Z3 | Attached | Not added | 101 |
| | (0.1 mole percent) | | |

As is clear from Table 1, Batteries A1 and A2, in which erbium oxyhydroxide was attached to the surfaces of the lithium transition metal oxide particles and lithium fluoride was added to the positive electrode, have a significantly reduced heating value as compared to Batteries Z1 to Z3 and are recognized to have significantly enhanced thermal stability. The reason for this is unclear and is probably as described below. After a system in which the positive electrode and an electrolytic solution are present reaches a high temperature, the nonaqueous electrolyte is oxidatively degraded on the surfaces of the lithium transition metal oxide particles by the catalysis of a transition metal in the lithium transition metal oxide, whereby the temperatures of the positive electrode and the electrolytic solution are further increased. When the positive electrode contains the lithium transition metal oxide particles and a metal fluoride, at least one portion of the surface of each lithium transition metal oxide particle has a rare-earth compound attached thereto, and the nonaqueous electrolyte contains a fluorine-containing lithium salt, the fluorine-containing lithium salt in the nonaqueous electrolyte heated to a high temperature is thermally degraded and the surface of the lithium transition metal oxide particle is covered with lithium fluoride, which is a degraded product of the fluorine-containing lithium salt. Therefore, the contact area between the transition metal in the lithium transition metal oxide and the nonaqueous electrolyte is reduced and the oxidation of the nonaqueous electrolyte is suppressed; hence, the heating value is reduced. In the case where the rare-earth compound is substantially uniformly attached to the surface of the lithium transition metal oxide particle, the surface of the lithium transition metal oxide particle is uniformly covered with lithium fluoride and the contact area between the transition metal in the lithium transition metal oxide and the nonaqueous electrolyte can be efficiently reduced.

When the positive electrode contains the metal fluoride, lithium fluoride is readily deposited on the surface of the lithium transition metal oxide particle. Furthermore, when a compound containing a rare-earth element with an electronegativity less than that of the transition metal is present on the surface of the lithium transition metal oxide particle, the surface of the lithium transition metal oxide particle is likely to attract lithium fluoride, which contains a fluorine atom with a large electronegativity. As a result, the deposition of lithium fluoride can be promoted.

Battery Z2, in which lithium fluoride was added to the positive electrode, has a reduced heating value as compared to Battery Z1, in which no lithium fluoride was added to the positive electrode, and is recognized to have no enhanced thermal stability. On the other hand, Battery Z3, in which erbium oxyhydroxide was attached to the surfaces of the lithium transition metal oxide particles, has no reduced heating value as compared to Battery Z1, in which no erbium oxyhydroxide was attached to the surfaces of the lithium transition metal oxide particles. Therefore, it is recognized that erbium oxyhydroxide does not contribute to thermal stability. However, Battery A1, in which erbium oxyhydroxide was attached to the surfaces of the lithium transition metal oxide particles and lithium fluoride was added to the positive electrode, has further enhanced thermal stability as compared to Battery Z2, in which no erbium oxyhydroxide was attached to the surfaces of the lithium transition metal oxide particles and lithium fluoride was added to the positive electrode. This shows that only attaching erbium oxyhydroxide to the surfaces of the lithium transition metal oxide particles does not enhance thermal stability and the interaction of erbium oxyhydroxide with the metal fluoride contained in the positive electrode enhances the thermal stability of a battery. Incidentally, even in the case of using a rare-earth compound containing another rare-earth element, a similar effect is probably achieved.

1-8. (canceled)

9. A nonaqueous electrolyte secondary battery, comprising:
a positive electrode comprising a positive electrode active material and a metal fluoride,
a negative electrode, and
a nonaqueous electrolyte comprising a fluorine-containing lithium salt,
wherein the positive electrode active material comprises lithium transition metal oxide particles, and
wherein at least one portion of the surface of each of the lithium transition metal oxide particles has a rare-earth compound attached thereto.

10. The nonaqueous electrolyte secondary battery according to claim 9, wherein the metal fluoride is LiF.

11. The nonaqueous electrolyte secondary battery according to claim 9, wherein, in the positive electrode, the ratio of the metal fluoride to the total mass of the lithium transition metal oxide is 0.1 mass percent to 5.0 mass percent.

12. The nonaqueous electrolyte secondary battery according to claim 9, wherein the rare-earth compound is at least one selected from the group consisting of hydroxides, oxyhydroxides, and oxides.

13. The nonaqueous electrolyte secondary battery according to claim 9, wherein the rare-earth compound comprises at least one rare-earth element selected from the group consisting of neodymium, samarium, and erbium.

14. The nonaqueous electrolyte secondary battery according to claim 13, wherein the ratio of the rare-earth element to the total molar amount of a transition metal in the lithium transition metal oxide is 0.003 mole percent to 0.25 mole percent.

15. The nonaqueous electrolyte secondary battery according to claim 9, wherein the lithium transition metal oxide particles comprise nickel and manganese.

16. The nonaqueous electrolyte secondary battery according to claim 9, wherein the lithium transition metal oxide particles are represented by the formula Li₁₊ₓNiₐMn_{b}CO_{c}O_{2+d},
wherein x, a, b, c, and d satisfy the following conditions:
x+a+b+c=1.0,
0≦x≦0.3,
0<a,
0<b,
0≦c, and
−0.1≦d≦0.1, and
wherein the lithium transition metal oxide particles have a layered structure.

17. The nonaqueous electrolyte secondary battery according to claim 9,
wherein a portion of the surface of each of the lithium transition metal oxide particles has the rare-earth compound attached thereto, and
wherein a portion of the surface of each of the lithium transition metal oxide particles does not have the rare-earth compound attached thereto.

18. The nonaqueous electrolyte secondary battery according to claim 17, wherein the rare-earth compound is uniformly dispersed on the lithium transition metal oxide particles.

19. The nonaqueous electrolyte secondary battery according to claim 9, wherein the rare-earth compound is uniformly dispersed on the lithium transition metal oxide particles.
